(19) United States
(12) Patent Application Publication
(10) Pub. No.: US 2025/0285601 A1
(43) Pub. Date: Sep. 11, 2025

(54) DISPLAY SYSTEM

(71) Applicant: Japan Display Inc., Tokyo (JP)

(72) Inventor: Hitoshi TANAKA, Tokyo (JP)

(21) Appl. No.: 19/073,462

(22) Filed: Mar. 7, 2025

(30) Foreign Application Priority Data
Mar. 11, 2024 (JP) 2024-036703

(51) Int. Cl. G09G 3/36; G09G 3/00

(52) U.S. Cl. CPC G09G 3/3607; G09G 3/001; G09G 3/3614; G09G 2320/0233

(57) ABSTRACT

A display system includes: a mounting unit to be worn on a head of a user so as to cover both eyes of the user; two display devices each having a display area provided with arrayed sub-pixels; and a drive circuit configured to output sub-pixel signals for displaying an image in the display area. In the display area, first sub-pixels are continuously arrayed along an inclined direction inclined with respect to the row and column directions, second sub-pixels are continuously arrayed along the inclined direction, and third sub-pixels are continuously arrayed along the inclined direction. The two display devices each include signal lines extending along the column direction and transmit the sub-pixel signals to the sub-pixels. The column direction of first display device, the inclined direction of the first display device, the column direction of second display device, and the inclined direction of the second display device are different directions.

### CROSS-REFERENCE TO RELATED APPLICATION

This application claims the benefit of priority from Japanese Patent Application No. 2024-036703 filed on Mar. 11, 2024, the entire contents of which are incorporated herein by reference.

### BACKGROUND

### 1. Technical Field

What is disclosed herein relates to a display system.

### 2. Description of the Related Art

Japanese Patent Application Laid-open Publications No. 2019-53152, No. 2019-148626, and No. 2019-148627 disclose virtual image display devices that are used in display systems, such as head-mounted displays (hereinafter, which may be referred to as HMDs).

HMDs include a display panel that displays images. If the display panel is a transmissive liquid crystal display, the display area of the display panel that displays images is provided with an array of sub-pixels including color filters. In such an HMD, the array of sub-pixels may be a mosaic array that produces higher-definition images than a stripe array does.

In an HMD, the display area of the display panel that displays images is positioned in front of the user's eyes. Therefore, the distance between the user's eyes and the display area is relatively short. This may possibly cause a phenomenon in which the user visually recognizes the array of sub-pixels as a mesh or stripe pattern (what is called the screen-door effect).

In the display panel, a plurality of signal lines that transmit signals for displaying images in the display area are arranged along the array of sub-pixels and parallel to each other. If the signals for displaying images are output by the column inversion driving method in which the polarity of the signals is periodically inverted, the luminance of the sub-pixels periodically changes depending on the polarity of the signals, which may possibly cause a phenomenon in which the user visually recognizes the array of sub-pixels as a stripe pattern.

For the foregoing reasons, there is a need for preventing a user from visually recognizing the array of sub-pixels as a stripe pattern in a display system that employs a mosaic array as the array of sub-pixels.

### SUMMARY

According to an aspect of the present disclosure, a display system includes: a mounting unit configured to be worn on a head of a user so as to cover both eyes of the user; two display devices each having a display area in which a plurality of sub-pixels are arrayed in a matrix having a row-column configuration; and a drive circuit configured to output sub-pixel signals for displaying an image in the display area. The sub-pixels include a plurality of first sub-pixels, a plurality of second sub-pixels, and a plurality of third sub-pixels. The color of the first sub-pixels, the color of the second sub-pixels, and the color of the third sub-pixels are different from one another. In the display area, the first sub-pixels, the second sub-pixels, and the third sub-pixels are arrayed such that the first sub-pixel, the second sub-pixel, and the third sub-pixel are repeatedly disposed along a row direction in the order as listed and that the first sub-pixel, the second sub-pixel, and the third sub-pixel are repeatedly disposed along a column direction in the order as listed. In the display area, the first sub-pixels are continuously arrayed along an inclined direction inclined with respect to the row direction and the column direction, the second sub-pixels are continuously arrayed along the inclined direction, and the third sub-pixels are continuously arrayed along the inclined direction. The two display devices each include a plurality of signal lines that extend along the column direction and transmit the sub-pixel signals to the sub-pixels. The display area of a first display device of the two display devices is arranged to face one of the eyes of the user, and the display area of a second display device of the two display devices is arranged to face the other of the eyes of the user. The two display devices are disposed in the mounting unit such that the column direction of the first display device, the inclined direction of the first display device, the column direction of the second display device, and the inclined direction of the second display device are different directions. The drive circuit outputs the sub-pixel signals by a column inversion driving method in which polarities of the sub-pixel signals are different between two signal lines adjacent to each other in the row direction and the polarities of the sub-pixel signals are periodically inverted.

### BRIEF DESCRIPTION OF THE DRAWINGS

FIG. 1 is a perspective view of a display system according to an embodiment of the present disclosure;

FIG. 2 is a schematic of the configuration of the display system;

FIG. 3 is a schematic of an arrangement of a display device in a mounting unit;

FIG. 4 is a schematic of the configuration of a display device;

FIG. 5 is a side view of the display device;

FIG. 6 is a diagram of a circuit configuration of a display panel;

FIG. 7 is a sectional view of the display panel;

FIG. 8 is a plan view of a display area illustrating the array of a plurality of sub-pixels in the display area of the display device; and

FIG. 9 is a diagram of an X1-direction, a Y1-direction, a column direction of a first display device, an inclined direction of the first display device, a column direction of a second display device, and an inclined direction of the second display device.

### DETAILED DESCRIPTION

An exemplary embodiment of the present disclosure is described below with reference to the accompanying drawings. The content described in the embodiment below is not intended to limit the present disclosure. Components described below include components easily conceivable by those skilled in the art and components substantially identical therewith. Furthermore, the components described below may be appropriately combined.

What is disclosed herein is given by way of example only, and appropriate modifications made without departing from the spirit of the present disclosure and easily conceivable by those skilled in the art naturally fall within the scope of the present disclosure. To simplify the explanation, the drawings may possibly illustrate the width, the thickness, the shape, and other elements of each component more schematically than the actual aspect. These elements, however, are given by way of example only and are not intended to limit interpretation of the present disclosure. In the present specification and the figures, components similar to those previously described with reference to previous figures are denoted by the same reference numerals, and detailed explanation thereof may be appropriately omitted.

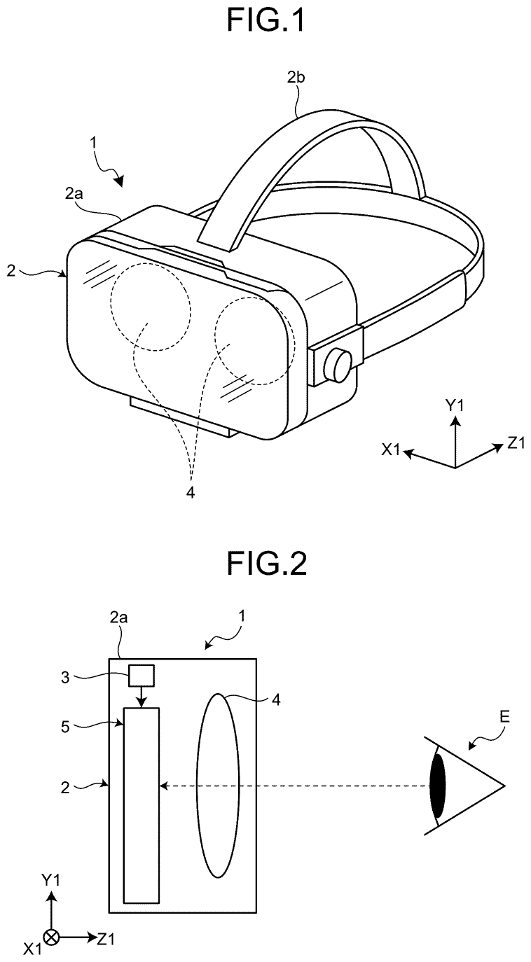

FIG. 1 is a perspective view of a display system 1 according to an embodiment of the present disclosure. FIG. 2 is a schematic of the configuration of the display system 1. The display system 1 is, for example, a head-mounted display. The display system 1 displays images, such as computer graphic video images and 360-degree real video images.

The display system 1 includes a mounting unit 2, a video signal source 3, two lenses 4, and a display device 5.

An X1-direction (corresponding to an “array direction”), a Y1-direction (corresponding to an “orthogonal direction”), and a Z1-direction illustrated in the drawings are orthogonal to each other and indicate the directions with respect to a body 2a of the mounting unit 2. The X1-, Y1-, and Z1-directions correspond to the width, height, and thickness directions of the body 2a. The X1-, Y1-, and Z1-directions are given by way of example only and are not intended to limit the present disclosure. In this specification, the side to which an arrow indicating a direction in the drawings points is a +side of the direction, and the side opposite to the side to which the arrow points is a −side. In the following description, for example, the side to which the arrow points in the Z1-direction is referred to as the +Z1 side, and the side opposite thereto is referred to as the −Z1 side.

Examples of the mounting unit 2 include, but are not limited to, a headset, goggles, a helmet, a mask, etc. The mounting unit 2 includes the body 2a and a belt 2b. The body 2a is provided with the video signal source 3, the two lenses 4, and the display device 5. The belt 2b is wound around the user's head to fix the body 2a to the user's head. The mounting unit 2 is worn on the user's head such that the body 2a covers both eyes of the user.

The video signal source 3 outputs, to the display device 5, image signals including information on images. The image signals include information on two different images using the parallax of the eyes of the user. The two images are an image for the user's right eye and an image for the user's left eye. The video signal source 3 outputs, to the display device 5, images stored therein in advance. The video signal source 3 includes, for example, a hard disk drive (HDD) and a flash memory. The video signal source 3 may be provided outside the mounting unit 2. In this case, the video signal source 3 is a computer (e.g., server) electrically coupled to the display device 5 in a wired or wireless manner.

The two lenses 4 are disposed at the positions facing user's eyes E. The lens 4 is a convex lens made of glass, for example. The two lenses 4 correspond to the eyes of the user. The lenses 4 are disposed between the display device 5 and the user's eyes E. With the effect of the lens 4, light output from the display device 5 is condensed to the user's eyes E. The user visually recognizes an image obtained by enlarging the image being displayed on the display device 5.

The display device 5 is disposed on the opposite side to the user's eyes E with the two lenses 4 therebetween.

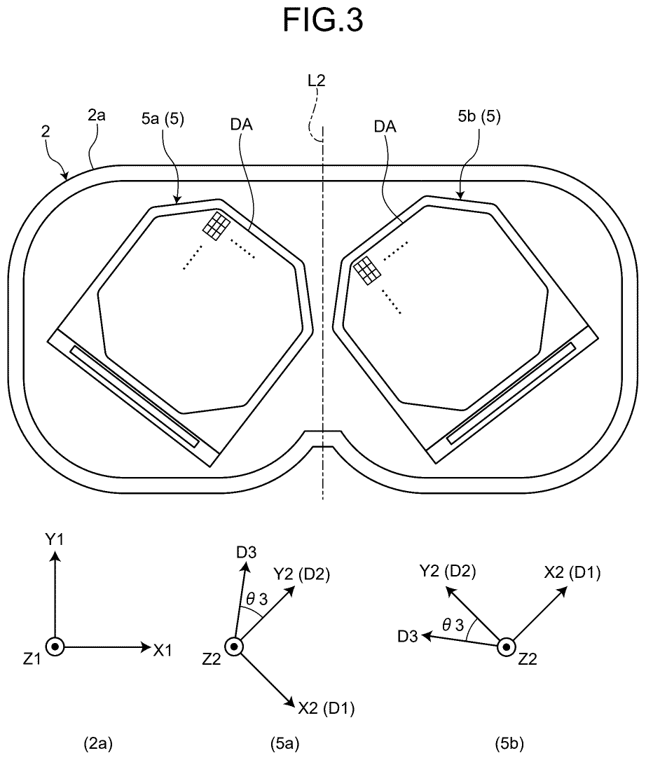

FIG. 3 is a schematic of an arrangement of the display device 5 in the mounting unit 2. The display system 1 includes two display devices 5. In other words, the display system 1 includes a first display device 5a and a second display device 5b. The first display device 5a and the second display device 5b have the same configuration.

The first display device 5a acquires an image for the left eye from the video signal source 3. A display area DA of the first display device 5a faces the user's left eye and displays the image for the left eye. The second display device 5b acquires an image for the right eye from the video signal source 3. The display area DA of the second display device 5b faces the user's right eye and displays the image for the right eye. The display area DA has a planar shape. The display area DA of the first display device 5a and the display area DA of the second display device 5b are positioned on a single plane orthogonal to the Z1-direction.

With the first display device 5a and the second display device 5b disposed in this manner, the direction in which the display area DA of the first display device 5a and the display area DA of the second display device 5b are arranged corresponds to the side-to-side (left-right) direction of the user's eyes. The direction in which the display area DA of the first display device 5a and the display area DA of the second display device 5b are arranged corresponds to the side-to-side (left-right) direction of the body 2a, that is, the X1-direction.

In FIG. 3, the arrows are illustrated that indicate the directions of the first display device 5a and the second display device 5b (which will be described later in detail). In the following description, the first display device 5a and the second display device 5b are referred to simply as the “display device 5” when they are not distinguished from each other.

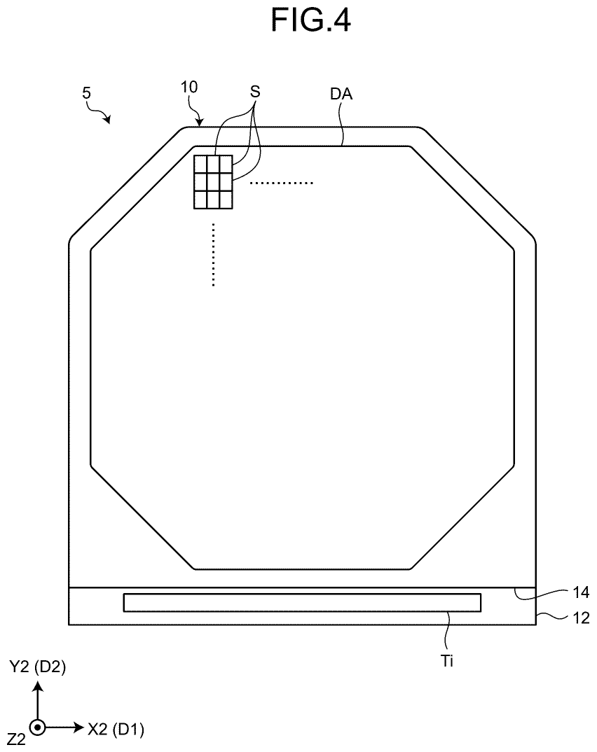

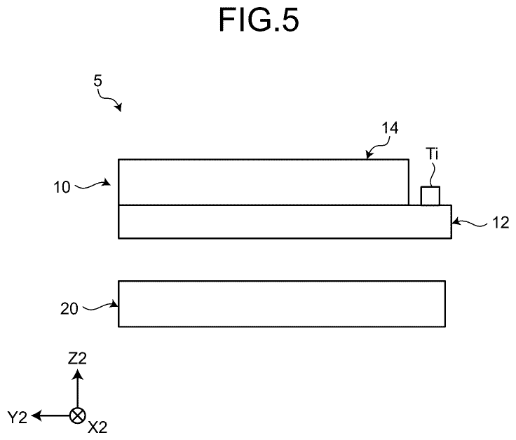

FIG. 4 is a schematic of the configuration of the display device 5. FIG. 5 is a side view of the display device 5.

In the following description, X2-, Y2-, and Z2-directions illustrated in the drawings are orthogonal to each other and indicate the directions with respect to the display device 5. The X2- and Y2-directions correspond to the directions parallel to the main surface of a substrate included in the display device 5. The Z2-direction corresponds to the direction orthogonal to the main surface of the substrate included in the display device 5. The Z2-direction corresponds to the thickness direction of the first display device 5. The side (+Z2 side) to which the arrow in the Z2-direction points corresponds to the front surface side where images are displayed in the first display device 5, and the side (−Z2 side) opposite thereto corresponds to the back surface side of the first display device 5. Viewing the display device 5 along the Z2-direction is referred to as “plan view”. The X2-, Y2-, and Z2-directions are given by way of example only and are not intended to limit the present disclosure.

The display device 5 includes a display panel 10 and a lighting device 20. The display panel 10 is a transmissive liquid crystal display.

The front surface of the display panel 10 has the display area DA in which images are displayed. The front surface of the display panel 10 is orthogonal to the Z2-direction. While the display area DA has a polygonal shape in plan view, it may have a rectangular shape.

A plurality of sub-pixels S are arrayed in a matrix (row-column configuration) in the display area DA. The sub-pixels S are arrayed in a matrix (row-column configuration) along a row direction D1 and a column direction D2 in plan view. The row direction D1 and the column direction D2 are orthogonal to each other. The row direction D1 is parallel to the X2-direction. The column direction D2 is parallel to the Y2-direction. The row direction D1 may be inclined with respect to the X2-direction. The sub-pixel S will be described later in greater detail.

The lighting device 20 is disposed on the back surface side of the display panel 10 and emits light toward the display panel 10. The lighting device 20 is what is called a direct-type backlight. The lighting device 20 includes a plurality of light-emitting diodes, for example.

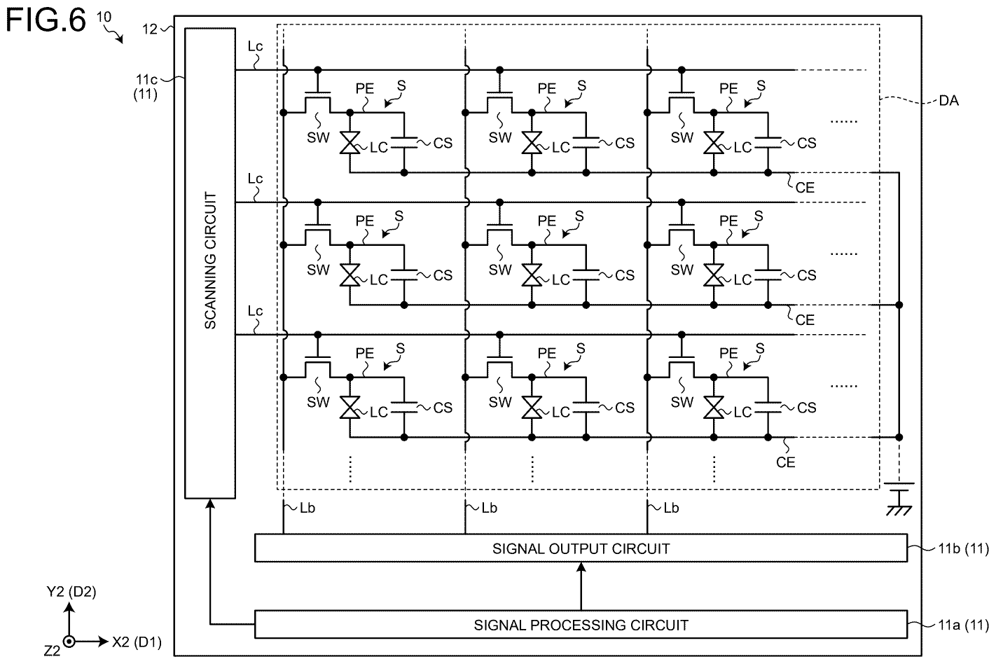

FIG. 6 is a diagram of a circuit configuration of the display panel 10. The display panel 10 includes a drive circuit 11. The display panel 10 also includes a switching element SW, a sub-pixel electrode PE, a common electrode CE, liquid crystal capacitor LC, and holding capacitor CS included in each of the sub-pixels S.

The drive circuit 11 displays images in the display area DA. The drive circuit 11 includes a signal processing circuit 11a, a signal output circuit 11b, and a scanning circuit 11c.

The signal processing circuit 11a generates a plurality of sub-pixel signals, which will be described later, based on the image signals transmitted from the video signal source 3 and outputs the generated sub-pixel signals to the signal output circuit 11b. The signal processing circuit 11a outputs, to the signal output circuit 11b and the scanning circuit 11c, clock signals for synchronizing the operation of the signal output circuit 11b with the operation of the scanning circuit 11c.

The signal output circuit 11b outputs the sub-pixel signals to the respective sub-pixels S. The signal output circuit 11b and the sub-pixels S are electrically coupled via a plurality of signal lines Lb extending along the column direction D2. In other words, the signal lines Lb extend along the column direction D2 and transmit the sub-pixel signals to the sub-pixels S.

The signal output circuit 11b outputs the sub-pixel signals by the column inversion driving method in which the polarities of the sub-pixel signals are different between two signal lines Lb adjacent to each other in the row direction D1 and the polarity of the sub-pixel signals is periodically inverted (e.g., every frame).

The scanning circuit 11c scans a plurality of sub-pixels S in synchronization with the output of the sub-pixel signals by the signal output circuit 11b. The scanning circuit 11c and the sub-pixels S are electrically coupled via a plurality of scanning lines Lc extending along the row direction D1.

The area partitioned by two signal lines Lb adjacent to each other in the row direction D1 and two scanning lines Lc adjacent to each other in the column direction D2 in plan view corresponds to one sub-pixel S.

The switching element SW is composed of a thin-film transistor (TFT), for example. In the switching element SW, the source electrode is electrically coupled to the signal line Lb, and the gate electrode is electrically coupled to the scanning line Lc.

The sub-pixel electrode PE is coupled to the drain electrode of the switching element SW. The common electrode CE is disposed corresponding to the sub-pixel electrode PE. The sub-pixel electrode PE and the common electrode CE have a light-transmitting property.

The liquid crystal capacitor LC is a capacitance component of the liquid crystal material of a liquid crystal layer 13, which will be described later, between the sub-pixel electrode PE and the common electrode CE. The holding capacitor CS is provided between the electrode with the same potential as that of the common electrode CE and the electrode with the same potential as that of the sub-pixel electrode PE.

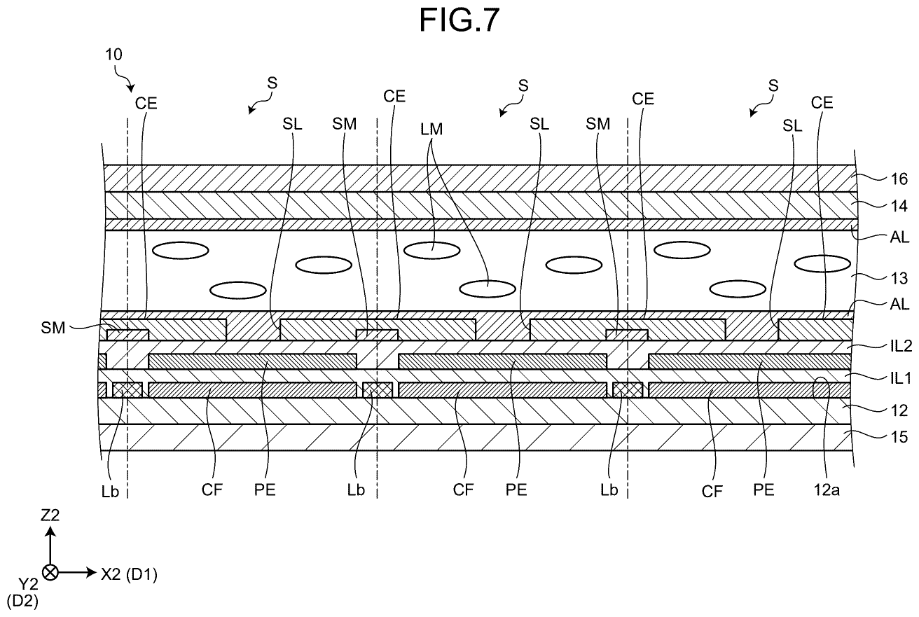

FIG. 7 is a sectional view of the display panel 10. The display panel 10 includes a first substrate 12, a liquid crystal layer 13, and a second substrate 14.

The first substrate 12, the liquid crystal layer 13, and the second substrate 14 have a light-transmitting property and are disposed in this order along the Z2-direction from the-side to the +side in the Z2-direction. The first substrate 12 is provided with an IC chip Ti constituting the drive circuit 11 (refer to FIGS. 4 and 5).

A main surface 12a corresponding to the front surface of the first substrate 12 is provided with the signal lines Lb and the scanning lines Lc (not illustrated in FIG. 7). The main surface 12a of the first substrate 12 is also provided with color filters CF. The color filters CF each have a rectangular shape in plan view and are disposed corresponding to the respective sub-pixels S.

The color filter CF has a light-transmitting property, and the peak of the spectrum of light to be transmitted through the color filter CF is determined in advance. The peak of the spectrum is one of the peaks of three spectra corresponding to three different colors. While the three colors are red, green, and blue, the number and type of colors are not limited thereto. In the following description, the color corresponding to the peak of the spectrum of light transmitted by the color filter CF is referred to as the color of the color filter CF. The color of the color filter CF corresponds to that of the sub-pixel S.

The first substrate 12 is also provided with the sub-pixel electrodes PE on the +Z2 side in the Z2-direction of the color filters CF and the signal lines Lb with an insulating layer IL1 interposed therebetween. The sub-pixel electrode PE overlaps the color filter CF in the Z2-direction.

The first substrate 12 is also provided with a light-shielding film SM, the common electrode CE, and an orientation film AL on the +Z2 side in the Z2-direction of the sub-pixel electrodes PE with an insulating layer IL2 interposed therebetween.

The light-shielding film SM has a light-shielding property. The light-shielding film SM overlaps the signal lines Lb and the scanning lines Lc in the Z2-direction. Specifically, the light-shielding film SM partitions the sub-pixels S. In other words, when viewed in the Z2-direction, the light-shielding film SM overlaps with the boundary of two sub-pixels S adjacent to each other in the row direction D1 and with the boundary of two sub-pixels S adjacent to each other in the column direction D2.

The common electrode CE is stacked on the light-shielding film SM, has slits SL, and is disposed to extend across two sub-pixel electrodes PE adjacent to each other in plan view. Thus, the common electrode CE and the sub-pixel electrodes PE are disposed on the first substrate 12. In other words, the display panel 10 is a lateral electric field liquid crystal display.

The liquid crystal layer 13 includes a plurality of liquid crystal molecules LM. The liquid crystal layer 13 is provided between two orientation films AL facing each other in the Z2-direction. The orientation of the liquid crystal molecules LM is regulated by the two orientation films AL. An orientation film AL is disposed on the back surface side of the second substrate 14.

The display panel 10 further includes a first polarizing plate 15 disposed on the back surface side of the first substrate 12 and a second polarizing plate 16 disposed on the front surface side of the second substrate 14.

The first polarizing plate 15 has a transmission axis orthogonal to the Z2-direction. The second polarizing plate 16 has a transmission axis orthogonal to the transmission axis of the first polarizing plate 15 and the Z2-direction.

Next, the operation of the display device 5 to display an image in the display area DA is described. When the display device 5 acquires the image signals transmitted from the video signal source 3, the display device 5 displays an image in the display area DA.

The image signals include the gradation values of the sub-pixels S corresponding to the image. The drive circuit 11 generates sub-pixel signals indicating the gradation values of the sub-pixels S and outputs the generated sub-pixel signals to the sub-pixels S. As a result, voltages corresponding to the gradation values indicated by the sub-pixel signals are applied to the liquid crystal layer 13 corresponding to the sub-pixels S, thereby inclining the liquid crystal molecules LM. The degrees of inclination of the liquid crystal molecules LM vary depending on the gradation values indicated by the sub-pixel signals.

Light emitted from the lighting device 20 is incident into the display panel 10. The light incident into the display panel 10 is colored by passing through the color filter CF and is incident into the liquid crystal layer 13. Due to the inclination of the liquid crystal molecules LM, the light passing through the liquid crystal layer 13 is modulated to the gradation values indicated by the sub-pixel signals. The light that has passed through the liquid crystal layer 13 exits from the display panel 10. As a result, an image is displayed in the display area DA.

Next, the array of the sub-pixels S in the display area DA is described.

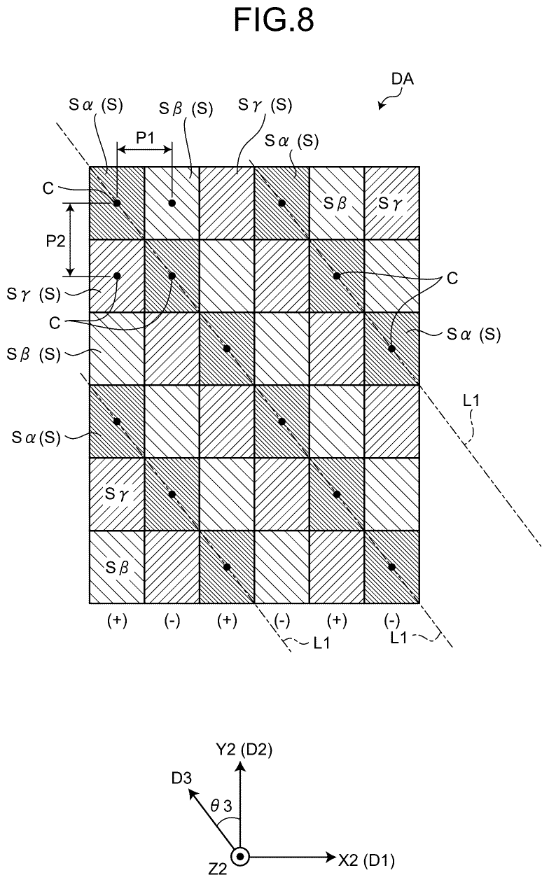

FIG. 8 is a plan view of the display area DA illustrating the array of the sub-pixels S in the display area DA of the display device 5. The sub-pixels S illustrated in FIG. 8 are some of the sub-pixels S arrayed in the display area DA. The sub-pixels S illustrated in FIG. 8 are indicated by the color filters CF and the light-shielding film SM. In plan view, the sub-pixels S are partitioned by the light-shielding film SM, and the color filter CF has a rectangular shape.

The sub-pixels S have the same rectangular shape in plan view. As described above, the sub-pixels S are arrayed in a matrix (row-column configuration) along the row direction D1 and the column direction D2 in plan view.

In the following description, a first pitch P1 denotes the distance between center points C of two sub-pixels S adjacent to each other in the row direction D1 out of the sub-pixels S in plan view, and a second pitch P2 denotes the distance between the center points C of two sub-pixels S adjacent to each other in the column direction D2 out of the sub-pixels S. The ratio of the second pitch P2 to the first pitch P1 according to the present embodiment is 4/3. The ratio of the second pitch P2 to the first pitch P1 may be 2. The ratio of the second pitch P2 to the first pitch P1 simply needs to be equal to or higher than 4/3 and smaller than 3.

The sub-pixels S include a plurality of first sub-pixels Sα, a plurality of second sub-pixels Sβ, and a plurality of third sub-pixels Sγ. The first sub-pixel Sα, the second sub-pixel Sβ, and the third sub-pixel Sγ have the color filters CF that are different in color, that is, the colors of these sub-pixels S are different from one another. The color of the first sub-pixel Sα is red. The color of the second sub-pixel Sβ is green. The color of the third sub-pixel Sγ is blue. In other words, the first sub-pixel Sα is a red sub-pixel S. The second sub-pixel Sβ is a green sub-pixel S. The third sub-pixel Sγ is a blue sub-pixel S. The colors of the sub-pixels S are not limited thereto.

In the following description, the first sub-pixel Sα, the second sub-pixel Sβ, and the third sub-pixel Sγ may be referred to simply as the “sub-pixel S” when they are not distinguished from one another.

In the display area DA, the first sub-pixels Sα, the second sub-pixels Sβ, and the third sub-pixels Sγ are disposed as illustrated in FIG. 8. The array of the sub-pixels S illustrated in FIG. 8 is what is called a mosaic array. Specifically, the first sub-pixel Sα, the second sub-pixel Sβ, and the third sub-pixel Sγ are repeatedly disposed in this order along the row direction D1 from the −D1 side (side opposite to the side to which the arrow points) to the +D1 side (side to which the arrow points) in the row direction D1 in plan view, and the first sub-pixel Sα, the second sub-pixel Sβ, and the third sub-pixel Sγ are repeatedly disposed in this order along the column direction D2 from the −D2 side (side opposite to the side to which the arrow points) to the +D2 side (side to which the arrow points) in the column direction D2.

In the mosaic array illustrated in FIG. 8, the sub-pixels S of the same color are continuously arrayed along an inclined direction D3 inclined with respect to the row direction D1 and the column direction D2 in plan view. In other words, the first sub-pixels Sα are continuously arrayed along the inclined direction D3 in plan view, the second sub-pixels Sβ are continuously arrayed along the inclined direction D3 in plan view, and the third sub-pixels Sγ are continuously arrayed along the inclined direction D3 in plan view. The inclined direction D3 is a direction in which a virtual line passing through the center points C of the sub-pixels S of the same color adjacent to each other extends. The virtual line L1 illustrated in FIG. 8 is a virtual line passing through the center points C of the red first sub-pixels Sα adjacent to each other.

In the stripe array, which is one of the arrays of the sub-pixels S, the first sub-pixel Sα, the second sub-pixel Sβ, and the third sub-pixel Sγ are repeatedly arrayed in this order along the row direction D1 from the −D1 side to the +D1 side in the row direction D1, and the sub-pixels S of the same color are continuously arrayed in the column direction D2. In the stripe array, the ratio of the second pitch P2 to the first pitch P1 is 3. Thus, the ratio is smaller in the mosaic array than in the stripe array. Therefore, the mosaic array can produce a higher-definition image than the stripe array can.

As described above, the distance between the display areas DA and the user's eyes is relatively short when the mounting unit 2 is worn on the user's head in a manner covering both eyes of the user. This may possibly cause a phenomenon in which the user visually recognizes the array of the sub-pixels S as a mesh or stripe pattern (what is called the screen-door effect (hereinafter, which may be referred to as SDE)).

For example, when only red is displayed in the display area DA, the luminance of the first sub-pixel Sα for displaying red is larger than 0, and the luminance of the second sub-pixel Sβ for displaying green and the luminance of the third sub-pixel Sγ for displaying blue are 0. Therefore, the first sub-pixel Sα displays red, and the second sub-pixel Sβ and the third sub-pixel Sγ display black. As described above, in the display area DA, the first sub-pixels Sα are continuously arrayed along the inclined direction D3, the second sub-pixels Sβ are continuously arrayed along the inclined direction D3, and the third sub-pixels Sγ are continuously arrayed along the inclined direction D3. In this case, the SDE may possibly occur in which the user visually recognizes a stripe pattern of alternately arrayed red and black rows extending along the inclined direction D3.

As described above, the first display device 5a and the second display device 5b are arranged along the X1-direction. In this case, if the inclined direction D3 of the first display device 5a matches the inclined direction D3 of the second display device 5b, the stripe pattern along the inclined direction D3 is emphasized and is more likely to be visually recognized by the user.

As described above, the drive circuit 11 outputs the sub-pixel signals by the column inversion driving method in which the polarities of the sub-pixel signals are different between two signal lines Lb adjacent to each other in the row direction Dl and the polarities of the sub-pixel signals are periodically inverted. The signal lines Lb extend along the column direction D2. Therefore, the polarities of the sub-pixel signals corresponding to the sub-pixels S arrayed along the column direction D2 are the same, and the polarities of the sub-pixel signals corresponding to two sub-pixels S adjacent to each other along the row direction D1 are different from each other.

For example, as represented by the symbols in the parentheses in FIG. 8, when the polarities of the sub-pixel signals corresponding to the sub-pixels S in the column on the most −D1 side are positive (+), the polarities of the sub-pixel signals corresponding to the sub-pixels S in the next column are negative (−). In other words, the polarities of the sub-pixel signals corresponding to the sub-pixels S are the same in the column direction D2 and are alternately positive and negative in the row direction D1.

The luminance of the sub-pixel S corresponding to the sub-pixel signal with the positive polarity may be different from that of the sub-pixel S corresponding to the sub-pixel signal with the negative polarity. Therefore, the luminances of the sub-pixels S are the same in the column direction D2, and the sub-pixels S with different luminances are alternately arrayed in the row direction D1. In this case, the difference in luminance of the sub-pixels S caused by the column inversion driving method generates a stripe pattern along the column direction D2, and the user may possibly visually recognize the stripe pattern.

As described above, the first display device 5a and the second display device 5b are arranged in the X1-direction. In this case, if the column direction D2 of the first display device 5a matches the column direction D2 of the second display device 5b, the stripe pattern along the column direction D2 is emphasized and is more likely to be visually recognized by the user.

If the inclined direction D3 of the first display device 5a matches the column direction D2 of the second display device 5b, the stripe pattern along the inclined direction D3 and the stripe pattern along the column direction D2 are emphasized and are more likely to be visually recognized by the user. The same applies to the case where the column direction D2 of the first display device 5a matches the inclined direction D3 of the second display device 5b.

To address this, as illustrated in FIG. 3, the two display devices 5 are disposed in the mounting unit 2 such that the column direction D2 of the first display device 5a, the inclined direction D3 of the first display device 5a, the column direction D2 of the second display device 5b, and the inclined direction D3 of the second display device 5b are different directions.

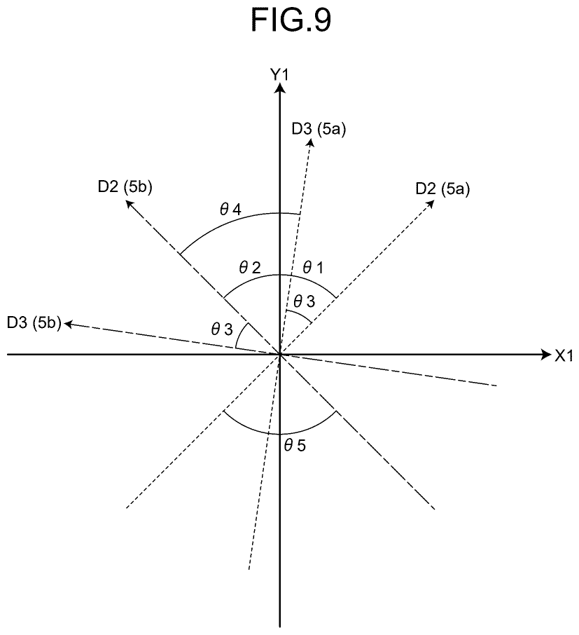

FIG. 9 is a diagram of the X1-direction, the Y1-direction, the column direction D2 of the first display device 5a, the inclined direction D3 of the first display device 5a, the column direction D2 of the second display device 5b, and the inclined direction D3 of the second display device 5b. In FIG. 9, the reference numerals for the directions corresponding to the first display device 5a are marked with “(5a)”, and the reference numerals for the directions corresponding to the second display device 5b are marked with “(5b)”.

In the present embodiment, a first angle θ1 between the Y1-direction orthogonal to the X1-direction in which the two display devices 5 are arranged and the column direction D2 of the first display device 5a is equal to a second angle θ2 between the Y1-direction and the column direction D2 of the second display device 5b in plan view. In other words, the two display devices 5 are disposed such that the column direction D2 of the first display device 5a and the column direction D2 of the second display device 5b are line-symmetrical with respect to the virtual line L2 (refer to FIG. 3) extending along the Y1-direction as the axis of symmetry.

In the present embodiment, the column direction D2 of the first display device 5a and the column direction D2 of the second display device 5b are orthogonal to each other. In other words, the first angle θ1 and the second angle θ2 are 45°.

When the ratio of the second pitch P2 to the first pitch P1 of the sub-pixels S is 4/3 as described above, a third angle θ3 between the column direction D2 and the inclined direction D3 is 36.8° in each of the first display device 5a and the second display device 5b.

When the column direction D2 of the first display device 5a and the column direction D2 of the second display device 5b are orthogonal to each other, a fourth angle θ4 between the inclined direction D3 of the first display device 5a and the column direction D2 of the second display device 5b is 53.2°.

Thus, when the column direction D2 of the first display device 5a, the inclined direction D3 of the first display device 5a, the column direction D2 of the second display device 5b, and the inclined direction D3 of the second display device 5b are different from one another, the direction of the stripe pattern (inclined direction D3) due to occurrence of the SDE does not match the direction of the stripe pattern (column direction D2) caused by the column inversion driving method in the two display devices 5. In other words, the stripe pattern along the inclined direction D3 and the stripe pattern along the column direction D2 are not emphasized. Therefore, the present embodiment can prevent the user from visually recognizing the array of the sub-pixels S as a stripe pattern in the display system 1 that employs a mosaic array as the array of the sub-pixels S.

If the array of the sub-pixels S is a stripe array, the direction of the stripe pattern due to occurrence of the SDE is the column direction D2. In this case, the direction in which the signal line Lb extends matches the column direction D2 of the sub-pixels S in each of the two display devices 5. Therefore, the direction of the stripe pattern (column direction D2) due to occurrence of the SDE matches the direction of the stripe pattern (column direction D2) caused by the column inversion driving method in each of the two display devices 5 independently of the directions in which the display devices 5 are disposed. Therefore, if the array of the sub-pixels S is a mosaic array as in the present embodiment, the user is less likely to visually recognize the stripe pattern than in the case where the array is a stripe array.

While the exemplary embodiment of the present disclosure has been described, the embodiment is not intended to limit the present disclosure. The contents disclosed in the embodiment are given by way of example only, and various modifications may be made without departing from the spirit of the present disclosure. Appropriate modifications made without departing from the spirit of the present disclosure naturally fall within the technical scope of the present disclosure.

While a fifth angle θ5 between the column direction D2 of the first display device 5a and the column direction D2 of the second display device 5b according to the embodiment described above is 90°, for example, the fifth angle θ5 may be smaller than 90°. In this case, the first angle θ1 and the second angle θ2 are preferably determined such that the fifth angle θ5 is within a range from 60° to 90°. When the ratio of the second pitch P2 to the first pitch P1 of the sub-pixels S is 4/3 as in the embodiment described above, it was found out that the stripe pattern is not visually recognized when the fifth angle θ5 is 60° and 90° by comparing the cases where the fifth angle θ5 is 0°, 30°,60°, and 90°. When the ratio of the second pitch P2 to the first pitch P1 of the sub-pixels S is 4/3 as in the embodiment described above, and the fifth angle θ5 is within a range from 60° to 90°, the fourth angle θ4 is within a range from 23.2° to 53.2°. By contrast, when the fifth angle θ5 is smaller than 60°, the fourth angle θ4 is smaller than 23.2°, and the inclined direction D3 of the first display device 5a and the column direction D2 of the second display device 5b are closer.

The first angle θ1 and the second angle θ2 may be different angles. In other words, the column direction D2 of the first display device 5a and the column direction D2 of the second display device 5b are not necessarily line-symmetrical.

The row direction D1 may be inclined with respect to the X2-direction. In this case, the column direction D2 is inclined with respect to the Y2-direction. Furthermore, the angle between the column direction D2 and the Y2-direction in the first display device 5a may be different from the angle between the column direction D2 and the Y2-direction in the second display device 5b. The row direction D1 and the column direction D2 may be inclined instead of being orthogonal to each other.

The display panel 10 described above may be a vertical electric field liquid crystal display in which the common electrode CE is disposed on the second substrate 14 to face the sub-pixel electrodes PE. Alternatively, the display panel 10 may be a reflective liquid crystal display.

Out of other advantageous effects achieved by the aspects described in the present embodiment, advantageous effects clearly defined by the description in the present specification or appropriately conceivable by those skilled in the art are naturally achieved by the present disclosure.

What is claimed is:

1. A display system comprising:
a mounting unit configured to be worn on a head of a user so as to cover both eyes of the user;
two display devices each having a display area in which a plurality of sub-pixels are arrayed in a matrix having a row-column configuration; and
a drive circuit configured to output sub-pixel signals for displaying an image in the display area,
wherein the sub-pixels include a plurality of first sub-pixels, a plurality of second sub-pixels, and a plurality of third sub-pixels,
wherein the color of the first sub-pixels, the color of the second sub-pixels, and the color of the third sub-pixels are different from one another,
wherein, in the display area, the first sub-pixels, the second sub-pixels, and the third sub-pixels are arrayed such that the first sub-pixel, the second sub-pixel, and the third sub-pixel are repeatedly disposed along a row direction in order as listed and that the first sub-pixel, the second sub-pixel, and the third sub-pixel are repeatedly disposed along a column direction in the order as listed,
wherein, in the display area, the first sub-pixels are continuously arrayed along an inclined direction inclined with respect to the row direction and the column direction, the second sub-pixels are continuously arrayed along the inclined direction, and the third sub-pixels are continuously arrayed along the inclined direction,
wherein the two display devices each comprise a plurality of signal lines that extend along the column direction and transmit the sub-pixel signals to the sub-pixels,
wherein the display area of a first display device of the two display devices is arranged to face one of the eyes of the user, and the display area of a second display device of the two display devices is arranged to face the other of the eyes of the user,
wherein the two display devices are disposed in the mounting unit such that the column direction of the first display device, the inclined direction of the first display device, the column direction of the second display device, and the inclined direction of the second display device are different directions, and
wherein the drive circuit outputs the sub-pixel signals by a column inversion driving method in which polarities of the sub-pixel signals are different between two signal lines adjacent to each other in the row direction and the polarities of the sub-pixel signals are periodically inverted.

2. The display system according to claim 1,
wherein a first angle and a second angle are equal to each other,
wherein the first angle is an angle between an orthogonal direction orthogonal to an array direction in which the two display devices are arranged and the column direction of the first display device, and
wherein the second angle is an angle between the orthogonal direction and the column direction of the second display device in plan view.

3. The display system according to claim 1,
wherein the ratio of a second pitch to a first pitch is equal to or higher than 4/3 and smaller than 3,
wherein the second pitch is a pitch of two sub-pixels of the sub-pixels that are adjacent to each other in the column direction in plan view, and
wherein the first pitch is a pitch of two sub-pixels of the sub-pixels that are adjacent to each other in the row direction in plan view.

4. The display system according to claim 1,
wherein the first sub-pixel is a red sub-pixel,
wherein the second sub-pixel is a green sub-pixel, and
wherein the third sub-pixel is a blue sub-pixel.
